(19) United States
(12) Patent Application Publication
(10) Pub. No.: US 2026/0280912 A1
(43) Pub. Date: Sep. 17, 2026

(54) OUTSOURCING COMPUTATIONS USING BLOCKCHAIN

(71) Applicant: nChain Licensing AG, Zug (GB)

(72) Inventor: Luigi LUNARDON, London (GB)

(21) Appl. No.: 19/469,791

(22) PCT Filed: Mar. 7, 2024
(86) PCT No.: PCT/EP2024/055965

§ 371 Date: Sep. 26, 2025

(30) Foreign Application Priority Data
Mar. 31, 2023 (GB) 2304772.3

(51) Int. Cl. H04L 9/00

(52) U.S. Cl. CPC H04L 9/50

(57) ABSTRACT

A computer-implemented method for outsourcing a computation using a blockchain, comprising: obtaining one or more respective secondary computations, wherein each respective secondary computation is based on a respective part of a primary computation and a respective verification algorithm, and wherein executing each respective secondary computation with a respective input generates a respective result of the respective part of the primary computation and a respective verification output of the respective verification algorithm; obtaining a plurality of respective inputs to the primary computation; and for each respective secondary computation: generating a respective outsourcing transaction, wherein the respective outsourcing transaction is locked to a respective locking value based on the respective verification output; making the respective outsourcing transaction available to a respective computing party; and making both the respective secondary computation, or an encrypted version thereof, and the respective input, or an encrypted version thereof, available to the respective computing party.

### CROSS REFERENCE TO RELATED APPLICATIONS

This application is the U.S. National Stage of International Application No. PCT/EP2024/055965 filed on Mar. 7, 2024, which claims the benefit of United Kingdom Patent Application No. 2304772.3 filed on Mar. 31, 2023, the contents of which are all incorporated herein by reference in their entireties.

### TECHNICAL FIELD

The present disclosure relates to methods for outsourcing a computation (e.g. training of a neural network) using a blockchain.

### BACKGROUND

Artificial intelligence (AI), machine learning (ML), and neural networks (NN) have proved that they can aid in everyday tasks, and even outperform humans in some cases. However, increased computational ability comes with economical and computational costs, and ethical and legal questions.

Progresses in ML reduce the economical and computational costs by providing models more suitable for specific tasks. However, big companies can provide more training data and deploy more resources are likely to outperform smaller companies and research institutions despite any theoretical breakthrough. Decentralized AI is an umbrella definition that covers a large spectrum of different machine learning techniques and architectures that share the property that parts of the AI can be distributed across different parties and devices. Decentralized (or distributed) machine learning (DML) is the subfield of ML that investigates the training and execution of distributed AI. The main research line in DML is known as federated learning (FL) and assumes decentralization of the training data. Decentralization can be achieved by different means (for instance, increasing the parallelization of the model), so FL is not the only form of DML.

Explainability of AI is a flourishing topic devoted to investigating the “thought process” of AIs. However, accessible and powerful NNs such as ChatGPT and Dall-E, gave new urgency to this discussion that is incompatible with the necessary research time. For this reason, topics such as auditing AI have become increasingly popular.

A shared common feature of ML techniques is that they rely on a set of data to run an optimization algorithm that improves the performance of the NN. This is commonly referred to as the training phase. DL investigates how to decentralize the training phase. Decentralization of the training phase can be achieved in multiple different ways. For instance, FL decentralizes the training data. More specifically, it studies how a global model can be trained using local models spread across multiple devices, relying on local independent data.

The internal parameters of the NN are adjusted based on the output of the training phase. The expected result of the training is an improvement in performance on data similar to that of the training set.

The improvement in the performances of NNs in recent years is due to three different factors: algorithmic innovations, availability of more data, and increased computational power. Algorithmic innovations are hard to track and measure, and in any case are not a focus of this application. The other two factors are closely related: more data results in larger models and longer training, which require increased computational power; similarly, more computational power allows to train larger models relying on larger sets of data. Increasing model size and training time results in increased costs for training and using the NN.

Companies and individuals rely on AI in many different fields daily. However, the improvements over the past few years caused concern and sparked the discussion on how deployed AI can be audited for harm by third party. The auditing process is beneficial both for users and deployers. The former is protected from possible harm, while the latter can use pre-emptive auditing to identify dangerous behaviours and intervene in time. Indeed, once the AI has been trained and deployed, it is difficult, and sometimes even impossible, to trace back the cause of these behaviours and modify them.

### SUMMARY

The present application disclosure provides techniques for implementing a protocol to distribute computations (e.g. a program or algorithm) across different devices using a blockchain, e.g. an unspent transaction output (UTXO) blockchain. The added benefits that blockchains can bring to existing DL protocols are discussed below. These include economical scalability of the training of models and the enhanced transparency of the auditing of models. Indeed, training and maintaining models (such as NNs) on blockchains may be, in the near future, the only scalable way to allow smaller companies and research institutions, with less computing power, to produce valuable and competitive Ais.

Note that the embodiments described herein, whilst particularly advantageous for use cases involving AI, ML and NN, may be used more generally to distribute any type of computation that can be separated (e.g. split, divided or unpacked) into multiple sub-computations.

Note that more generally the described embodiments may be used to outsource any computation, not necessarily one that is split into multiple components. That is, an entire computation may be outsourced as a whole.

According to one aspect disclosed herein, there is provided a computer-implemented method for outsourcing a computation using a blockchain, wherein the method is performed by a coordinating party and comprises: obtaining one or more respective secondary computations, wherein each respective secondary computation is based on a respective part of a primary computation and a respective verification algorithm, and wherein executing each respective secondary computation with a respective input generates a respective result of the respective part of the primary computation and a respective verification output of the respective verification algorithm; obtaining a plurality of respective inputs to the primary computation; and for each respective secondary computation: generating a respective outsourcing transaction, wherein the respective outsourcing transaction is locked to a respective locking value based on the respective verification output; making the respective outsourcing transaction available to a respective computing party; and making both the respective secondary computation, or an encrypted version thereof, and the respective input, or an encrypted version thereof, available to the respective computing party.

According to one aspect disclosed herein, there is provided a computer-implemented method for performing an outsourced computation using a blockchain, wherein the method is performed by a first computing party and comprises: obtaining a first secondary computation, wherein the first secondary-computation comprises a primary computation or a first part of the primary computation, and a first verification algorithm; obtaining a first input to the primary computation; obtaining a first outsourcing transaction, wherein the first outsourcing transaction is locked a first locking value based a first verification output obtainable by inputting the first input to the first verification algorithm; executing the first secondary computation using the first input, wherein said execution produces a first result based on the primary computation or the first part of the primary computation, and the first verification output; making the first result, or an encrypted version thereof, available to a coordinating party; generating a first result transaction, wherein the first result transaction references the first outsourcing transaction and comprises an unlocking value based on the first verification output; and making the first result transaction available to one or more nodes of a blockchain network.

Embodiments of the present disclosure involve outsourcing a computation to one or more computing parties who may, for example, having more computing power available than the outsourcing party. This may include having more computing power general (e.g. better hardware) or have more computing power at the time of outsourcing (e.g. due to an increased but temporary demand for computing power).

In some embodiments, the coordinating party and the outsourcing party are the same entity. In other embodiments, the coordinating party and the outsourcing party are different entities. Regardless, the coordinating party obtains a primary computation (i.e. an algorithm, such as training a neural network) that it is to be outsourced. One or more secondary (or sub, or micro) computations are produced, e.g. by splitting the primary computation into component parts. Each secondary computation includes a verification algorithm, e.g. the verification algorithm is combined with the secondary computation. The coordinating party may produce the secondary computations, or the secondary computations may be sent to the coordinating party by the outsourcing party. Execution of the secondary computation (e.g. the combination of part of the primary computation and verification algorithm) produces two outputs: a result of the primary computation or a part of the primary computation and a verification value. The verification value can only feasibly be obtained by running the secondary computation. E.g. it may only be economically advantageous to run the secondary computation to obtain the verification value.

For each secondary computation, a transaction is sent to the blockchain, whereby the transaction (e.g. an output of the transaction in the case of a UTXO blockchain) is locked to a locking value based on the corresponding verification value. The locking value may be part of a hash puzzle, for instance. In order to unlock the (output of) the transaction, a computing party must execute the secondary computation in order to obtain the verification value. In doing so, the computing party also obtains a result of (part of) the primary computation. The result is provided to the coordinating party. By unlocking the transaction (output), the coordinating party can be sure that the computing party must have executed the secondary computation, and therefore can be confident that the provided result is a result of (part of) the primary computation.

An illustrative use case, which is discussed in more detail below, involves three actors: an outsourcer (Olivia), a recognized central service (ReCeS), and a user willing to lend their computational power (Ulysses). Olivia is a researcher that is training a large NN. She designed the network architecture and prepared the training and testing set, but her computational power is limited, and she knows training it using her local resources may require a lot of time. ReCeS is a service offered by her university to borrow computational power from idle campus machines and registered university staff and users. Thread-level parallelism (or other suitable types of parallelism) protocols may be implemented in ReCeS to split the computations. Lending computational power is rewarded.

Further advantages of the described embodiments are provided below in section XX.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a schematic block diagram of a system for implementing a blockchain,

FIG. 2 schematically illustrates some examples of transactions which may be recorded in a blockchain, and

FIG. 3 is a schematic block diagram of a system for outsourcing computations.

### DETAILED DESCRIPTION OF EMBODIMENTS

### 1. Outsourced Computations

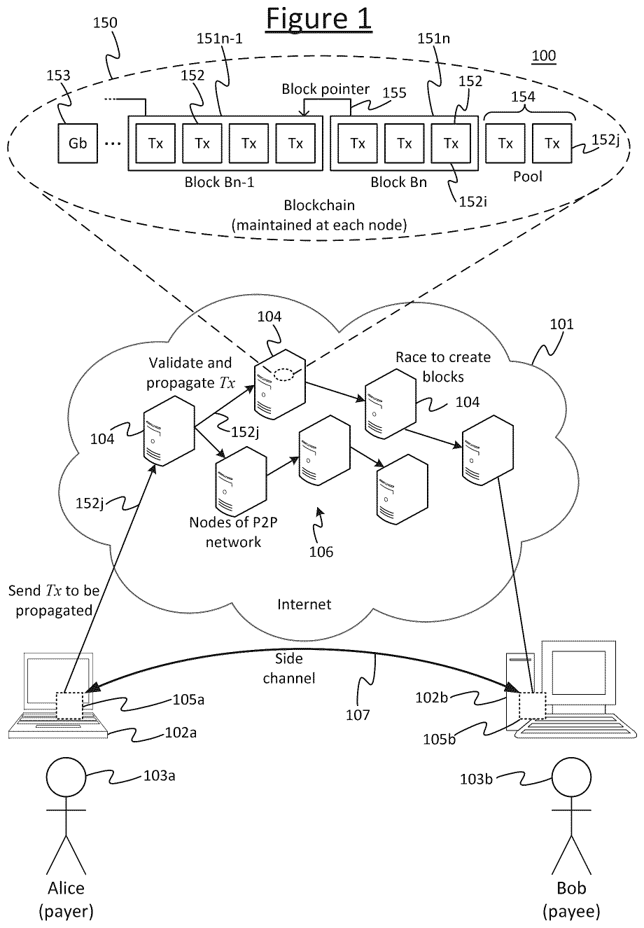

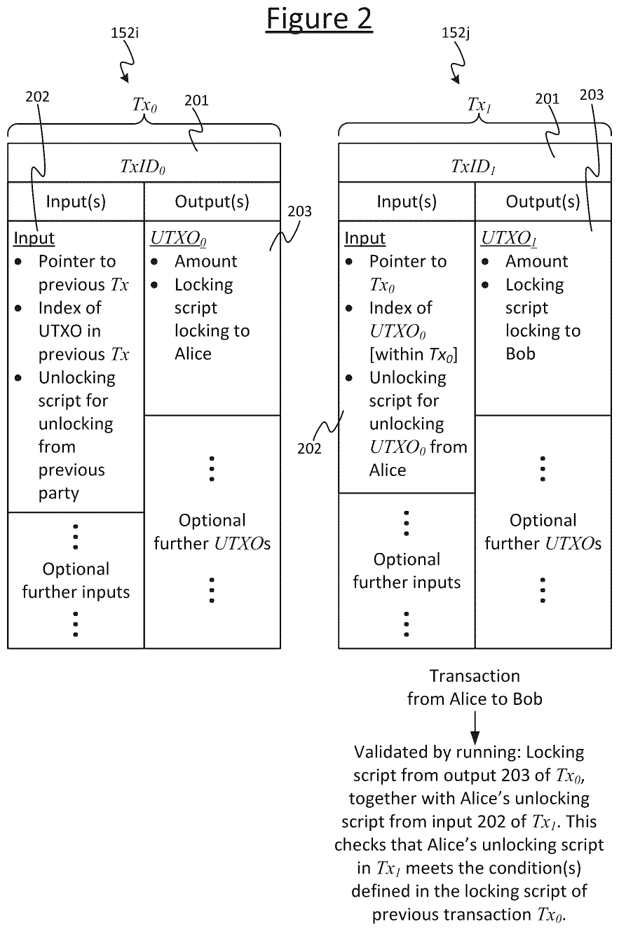

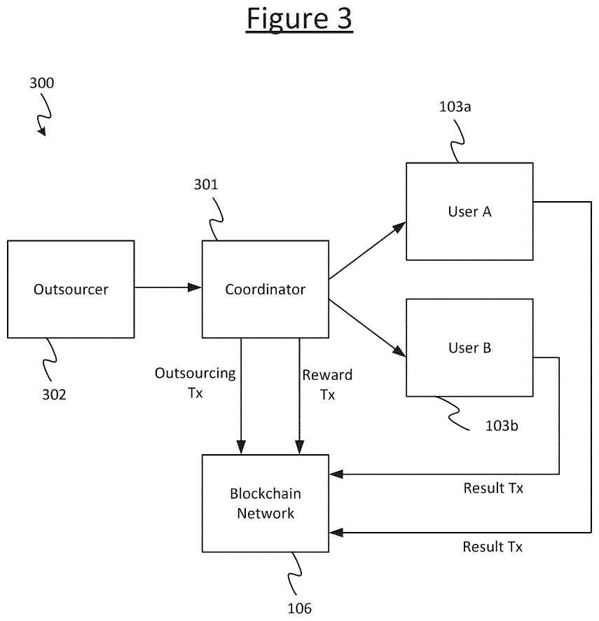

FIG. 3 shows an example system 300 for implementing a protocol for outsourcing computations. The system 300 includes a coordinating party (“coordinator”) 301, an outsourcing party (“outsourcer”) and one or more computing parties (“users”) 103a. Whilst shown separately, in some examples the coordinator 301 may be the same entity as the outsourcer 302. Only two users 103 are shown in FIG. 3 but in general the system 300 may include any number of users. Note that whilst the computing parties 103 are referred to as “users”, they may take any form, e.g. an individual user, a group of users, a machine, etc. For ease, a first user (“User A”) will be referred to as Alice 103a and a second user (“User B”) will be referred to as Bob 103b. However in general any user may be configured to perform any actions described below as being performed by Alice 103a and/or Bob 103b with reference to FIGS. 1 and 2. The same applies to the coordinator 301 and the outsourcer 302. Note that unless the context requires, “first”, “second”, and so are used merely as distinguishing labels, and do not necessarily imply a particular order.

By way of example, embodiments will be described in terms of the outsourcer 302 being separate from the coordinator 301. However it should be appreciated that any action described as being performed by the outsourcer 302 may instead be performed by the coordinator 301, unless the context requires otherwise.

The outsourcer 302 sends a computation (a “primary computation”) to the coordinator 301. The outsourcer 302 may send the source code of the primary computation, or a representation, or a description, or even an image of the primary computation (e.g. showing a circuit with gates etc.). The primary computation may be any type of computation, i.e. calculation, algorithm, process, etc. In some examples, the primary computation comprises a neural network.

The outsourcer 302 also sends one or more inputs to the primary computation to the coordinator 301. The inputs may take any form, e.g. numerical values, strings, a combination of the two. In some examples, the inputs are training data for a neural network. The inputs may be sent in an encrypted form. For instance, the inputs may be encrypted with the coordinator's public key, or with an encrypted key which is sent, separately, from the outsourcer 302 to the coordinator 301.

The coordinator 301 generates one or more secondary computations based on the primary computation. In some examples, a plurality of secondary computations are produced. In these examples, each secondary computation includes a part (i.e. component, section, etc.) of the primary computation. In addition, each secondary computation also includes a verification algorithm. Alternatively, a single secondary computation includes the entire primary computation. Each secondary computation may include the same verification algorithm or a different verification algorithm. The secondary computations may be generated in any suitable way. As an example, the primary computation may be first split into component parts, and then each component part combined with a verification algorithm. Here, “combining” is not limited to concatenating, for example, and may involve other operations to generate a secondary computation based on a part of the primary computation and a verification algorithm. As another example, one or more verification algorithms may first be combined with the primary computation, with the resulting combination then split into multiple secondary computations.

In some embodiments, the outsourcer 302 generates the secondary computations and sends them to the coordinator 301. The secondary computations may be sent in the clear, or encrypted. For example, the secondary computations may be encrypted with the coordinator's public key, or with an encrypted key which is sent, separately, from the outsourcer 302 to the coordinator 301.

Executing a component part of the computation based on one or more of the inputs produces a result of that part of the computation (a “partial result”). Executing the verification algorithm based on one or more of the inputs produces a verification output. In other words, executing a secondary computation based on one or more inputs produces a partial result and a verification output. The secondary computations are generated such that the component part of the computation must be executed in order to execute the verification algorithm and obtain the verification output. Typically the computation, and component parts of the computation, will be harder to execute (i.e. require more processing power or resources) than the verification algorithm. In some examples, the secondary computations are compiled such that it is not possible (or at least not easy) to obtain, separately, the component part of the computation and the verification algorithm.

In some examples, each secondary computation or each component part of the primary computation is assigned an identifier. The verification algorithm of a given secondary computation may be a function of the assigned identifier. The verification algorithm may additionally or alternatively be a function of a seed provided by the outsourcer 302. For example, each verification algorithm may be based on a hash of the identifier and seed.

For each secondary computation, the coordinator 301 generates an outsourcing transaction that is locked to a ‘locking value’ based on the verification output generated by executing the verification algorithm of the secondary computation. If implemented on a UTXO-based blockchain, like Bitcoin, it is an output of the outsourcing transaction that is locked to the locking value. Embodiments may instead use an account-based blockchain. Here, “locked to the locking value” means that in order to be unlocked, either the verification output or a value (e.g. a hash) based on the verification output must be provided in (an input of) a spending transaction that references (the output of) the outsourcing transaction. For example, a smart contract may determine whether an input based on the verification output has been provided.

The locking value may be a hash (or double hash) of at least the verification output. The locking value may be a hash (or double hash) of the verification output and a public key of a user 103, or a function thereof, such as summation or concatenation. In these examples, the outsourcing transaction may include a script (e.g. a locking script) configured to implement a hash puzzle based on the locking value.

In some examples, the outsourcing transaction (e.g. the output of the outsourcing transaction) may be locked to a public key of a user 103. That is, a signature generated using a private key corresponding to the public key of the user 103 must be provided to unlock (the output of) the outsourcing transaction. Additionally or alternatively, the outsourcing transaction (e.g. the output of the outsourcing transaction) may be locked to a public key of the coordinator 301. This may be used to allow the coordinator 301 to reclaim any digital asset locked by the outsourcing transaction if, for example, the user 103 does not provide a result to the secondary computation (discussed more below).

Each outsourcing transaction may include a hash of at least the corresponding secondary computation.

In some examples, rather than creating a separate outsourcing transaction for each secondary computation, a given outsourcing transaction may include multiple outputs, each for a different secondary computation, i.e. each locked to a different verification output of the verification algorithm used to generate the different secondary computation.

The coordinator 301 submits the outsourcing transactions to the blockchain network 106. Additionally or alternative, the outsourcing transactions may be sent to one or more users 103, e.g. an outsourcing transaction locked to a user's public key may be sent to that user 103. For example, as shown in FIG. 3, one outsourcing transaction is sent to Alice 103a and one outsourcing transaction is sent to Bob 103b.

The coordinator 301 also sends the secondary computations to one or more users 103. In some examples, a given secondary computation is only sent to the user 103 whose public key is used to lock the outsourcing transaction associated with that secondary computation. The secondary computations may be sent in encrypted form. Any suitable encryption method may be used, e.g. using the user's public key or a dedicated encryption key. In some examples, rather than sending the secondary computations directly to the user(s) 103, the coordinator 103 may include, in the associated outsourcing transaction, a link or reference to a storage location where the secondary computation is stored, e.g. in cloud storage.

Turning now to the perspective of a user 103 configured to perform an outsourced computation. A user, say Alice 103a, obtains a first secondary computation. Recall that “first” and so on are used merely as labels, and so “first secondary computation” does not necessarily mean the initial secondary computation to be created or distributed, or that it comprises an initial part of the main computation. Alice 103a may obtain the first secondary computation directly from the coordinator 301. Alice 103a may instead obtain the first secondary computation from a storage location, e.g. cloud storage, using a link or reference to the storage location. The link or reference may be included in a first outsourcing transaction. The first outsourcing transaction may contain a hash of the first secondary computation. Alice 103a may hash the obtained first secondary computation and compare it to the hash found in the first outsourcing transaction. Alice 103a may first obtain an encrypted version of the first secondary computation and then use a decryption key to reveal the first secondary computation. Alice 103a similarly obtains a first input to the first secondary computation, i.e. an input that will be input to the component part of the main computation upon which the first secondary computation is based. Alice 103a either obtains the first outsourcing transaction from the blockchain 510 itself or from the coordinator 301.

Using the first input, Alice 103a executes the first secondary computation. As described above, this produces two outputs: an output (a “result”) of part of the main computation and an output (a “first verification output”) of the verification algorithm. Alice 103a generates a first result transaction that references the first outsourcing transaction. The first result transaction includes an “unlocking value” based on the first verification output. The unlocking value may be the first verification output itself, or a hash of at least the first verification output, depending on the form of the locking value of the first outsourcing transaction. If required, Alice 103a signs the first outsourcing transaction. Alice 103a then sends the first result transaction to the blockchain 150 and/or to the coordinator 301.

Alice 103a sends the result to the coordinator 301. Or, Alice 103a may include a link or reference to the result in the first result transaction. Alice 103a may first encrypt the result.

Alice 103a may perform similar actions for multiple secondary computations. Bob 103a may also perform similar actions for one or more secondary computations.

The coordinator 301 obtains multiple results, e.g. directly from the users 103 or from links provided in the result transactions. The coordinator 301 may send the multiple results to the outsourcer 302, or generate an overall result based on the multiple results and send the overall result to the outsourcer 302. In some examples, the identifier associated with each secondary computation is used to generate the overall result based on the multiple results.

### 1.1 Outsourcing Computations

This section describes an example protocol that implements the embodiments described above. Continuing with the earlier described example, this protocol has three main actors: an outsourcer (Olivia) 302, a recognized central service (ReCeS) 301, and a computing party (Ulysses) 103.

While transactions may be used to execute computations, in some cases this will be inefficient and expensive. Instead, transactions may be created that contain a link to the computation to be outsourced and a cryptographic hash of its content to ensure data integrity. These transactions are referred to as outsourcing transactions.

A verification script is a computationally light function added to the outsourced computation. The example verification script described in this section is computed deterministically using a seed agreed upon between Olivia and ReCeS.

Let P_{U} be the public key of Ulysses, P_{R} the public key of ReCeS, V_{O} the output of the verification script, f a known function, H a cryptographic hash function, and K=H²(f(P_{U}, V_{O})), where H² means the double hash is applied. An example of a verification script written in Script SV is below (we omit the OP_ at the beginning):
1<P_{U}><P_{R}>2 CHECKMULTISIGVERIFY SHA256<K>EQUAL.

The unlocking script is H(f(P_{U}, V_{O})) and a signature generated with the private key corresponding to P_{U}. Additional data D (such as the hash of the input) may be added, by appending OP_RETURN<D> to the end of the script.

Outsourcing transactions are sent from ReCeS to its registered users. Once Ulysses completes the computation, he has the verification output needed to spend the transaction. If he disconnects before finishing a computation or it is not providing the answer, ReCeS may cancel the transaction and rebroadcast the computation.

The verification script is preferably computationally light, depends on the input of the computation, and should ensure the verification output has a degree of randomness. Let H₁ and H₂ be two different cryptographic hash functions and S the seed of a pseudo-random number generator (PRNG).
1. Generate a random positive integer n using the RNG. Let H←H₁.
2. Use the RNG to pick a random input i and a random integer a. Let V_{O}=H(H(i)+H(a).
3. If n is odd, update H (if H is H₁, set it to H₂, or if H is H₂, set to H₁) and use the RNG to pick a random input j and a random integer b. Let V=H(H(j)+H(b). Let r be the remainder of the division of n by 4.
   a. If r=0, V_{O}←H₁(V_{O}).
   b. If r=1, V_{O}←V_{O}XOR V.
   c. If r=1, V_{O}←H₂(V_{O}).
   d. If r=3, V_{O}←NOT (V_{O} XOR V).
4. Update n←└n/4┘ and repeat Step 3 until n=0.
5. If V_{O}=2^{m}−1 for some integer m, return to Step 1.

Providing the source code of the computation exposes ReCeS to malicious parties that could extract only the verification script and still unlock the transaction. On the other hand, providing an executable exposes Ulysses to malicious attacks and unintentional denial of service. To address these problems, ReCeS may provide a domain-specific programming language that can describe a broad spectrum of computations but is limited enough to ensure that cannot insert malicious or dangerous code. ReCeS sends to Ulysses an executable in the outsourcing transaction.

It may be convenient—and often necessary—to encrypt the input that Ulysses receives (when dealing with confidential data, for instance). Decrypting the data may be done by the executable.

To prevent Ulysses from sharing manipulated results or an eavesdropping party to manipulate them, the output data may be encrypted before being sent to ReCeS. To verify the computation, ReCeS may decrypt the data and check that the verification outputs are consistent.

A high-level description of the source code used to produce the executable is below:
1. Load the input and the seed needed for the verification script and decrypt them.
2. Execute the required computation and the verification script and produce the outputs O₁ and O₂, respectively.
3. Encrypt the total output O=(O₁, O₂) and share it to ReCeS.
4. Show the verification output in clear form to Ulysses.

Once the computation is completed, ReCeS may check the encrypted verification code corresponds with the non-encrypted one, and so the data were not manipulated. At this point it may send a reward transaction to Ulysses. The reward transaction may be a standard P2PKH transaction to Ulysses address with a reference to the computation it is referring to.

Thus, the total reward Ulysses receives is split between two different transactions, and he can receive the full reward only if both parties agree on the correct execution of the computation. Splitting the total reward in two transactions partially protects all parties from financial losses in case of attacks: if Ulysses is honest and a third party manipulated the result, he still receives partial reward; if the computation is not correct, ReCeS does not create the reward transaction.

### 1.2 Training Artificial Intelligence Using a UTXO-Based Blockchains

This section describes an example outsourcing protocol that uses the embodiments described above to train a NN. Training paradigms, such as DL and FL, that already assume fragmentation in the training phases are particularly suitable for this protocol.
1. Olivia describe the NN architecture and the training algorithm using a domain-specific language provided by ReCeS.
2. Olivia sends the source code, the training set, a secret seed S, and an encryption key E to ReCeS.
3. ReCeS unpacks the computation into smaller ones using its task parallelization protocols.
4. ReCeS assigns a sequential identification number Cᵢ and a total reward Tᵢ to each of the smaller transactions. Tᵢ is split in two values, one used for the outsourcing transaction and one used for the reward transaction.
5. ReCeS sets the seed used to create the verification script of the transaction Cᵢ to H(S+Cᵢ), where H is a cryptographic hash function.
6. ReCeS encrypts the transaction inputs and generates the source codes. It then compiles and obfuscates them.
7. ReCeS creates proof of existence (PoE) of the encrypted inputs and of the executables.
8. ReCeS distributes the computation using outsourcing transactions to Ulysses.
9. Ulysses checks the executable and the input provided to ensure data integrity.
10. Ulysses runs the executable. The result of the computation and the verification output are encrypted and shared with ReCeS. The verification output is sent to Ulysses.
11. Ulysses spends the outsourcing transaction.
12. ReCeS decrypts what Ulysses shared, verifies the correctness of the results by checking that the verification output is consistent.
13. Upon successful verification, ReCeS sends the reward transaction to Ulysses.
14. When Ulysses disconnects from the service, ReCeS spends his outsourcing transactions.
15. Once the model is trained, ReCeS sends it to Olivia.

The following describes further specifics of the described protocol.
1. The university is incentivised to support a service such as ReCeS for economic reasons. Idle machines on campus can be used instead of dedicated hardware. The users can be paid in tokens.
2. In Step 2, Olivia can aim at reducing the computational time or the economic cost of the outsourcing. She can pay for this service relying on the token economy provided by ReCeS.
3. The PoE of the data ReCeS uses to distribute the computations may be saved on chain to allow Ulysses to verify he is running the correct program on the correct inputs.
4. All the information provided in the link of the outsourcing transaction may be deleted after the computation is completed. The version of ReCeS Olivia interacted with, the data she shared with it and all the transactions on chain is all that is needed to ensure it is possible to reconstruct the computation. This enables auditing the NN. The data may be combined in a Merkle tree structure to allow selective disclosure.
5. The PoE of additional partial information such as training steps may be saved. This may help researchers and institutions investigate specific behaviours.
6. This protocol is especially suitable for FL. It may be modified so that Ulysses is able to train the model on local data he provides. To do this, Ulysses must first save the PoE of the data, and then share them with ReCeS so that it can compute the verification output and the outsourcing transaction.
7. Since the outsourcing transaction locking script is linked to Ulysses' address, replay attacks are not possible.
8. Having a trusted institution behind ReCeS removes the risk of transaction malleability.

### 1.3 Benefits of Distributed Learning Using Blockchains

This section discusses some of the advantages of using blockchains for outsourcing computations, e.g. to train AI.

### 1.3.1 Decentralization and Privacy

An advantage of training AIs on a blockchain is its inherent decentralization and privacy.

Blockchain allows existing DL and FL models to integrate local training data preserving the privacy of the user and the confidentiality of the data. Despite all of this, it is still possible to audit the data at a later stage; this prevents data poisoning by making users accountable for the provided data.

### 1.3.2 Data Integrity

Users willing to lend computational power need to be able to autonomously verify that the data they are using have not been corrupted. Checking the PoE of the data is an effortless way to achieve this.

### 1.3.3 Selective Disclosure

Selective disclosure of confidential data can be achieved via PoE. A naïve way to do this is to save the PoE of all the different clearance levels on the blockchain, but this can be a slow process (especially for large data). A better approach is to use Merkle trees as it requires saving the data only once, relying on Merkle proof to ensure data integrity.

### 1.3.4 Auditability

Data integrity and selective disclosure are the fundamental blocks that make blockchain a natural framework for AI auditability. The outsourcing protocol described herein stores information on the initialization of the parameters and the training set on the blockchain. If needed, additional information required from auditing parties may be stored. All intermediate training steps may be saved on the blockchain as transactions. If a party is providing training data, PoE may be required so that the service can verify data integrity before using the data. All this information may be stored on the blockchain by saving only the root of a Merkle tree. Internal and external auditing needs only the original data and their Merkle proofs to ensure data integrity. Not only the training but also the execution of the AI can be processed via micro-transactions. These micro-transactions create a reliable stream of information on the AI usage that can be used to develop appropriate legal coverage for companies and individuals.

### 2. Example System Overview

A blockchain refers to a form of distributed data structure, wherein a duplicate copy of the blockchain is maintained at each of a plurality of nodes in a distributed peer-to-peer (P2P) network (referred to below as a “blockchain network”) and widely publicised. The blockchain comprises a chain of blocks of data, wherein each block comprises one or more transactions. Each transaction, other than so-called “coinbase transactions”, points back to a preceding transaction in a sequence which may span one or more blocks going back to one or more coinbase transactions. Coinbase transactions are discussed further below. Transactions that are submitted to the blockchain network are included in new blocks. New blocks are created by a process often referred to as “mining”, which involves each of a plurality of the nodes competing to perform “proof-of-work”, i.e. solving a cryptographic puzzle based on a representation of a defined set of ordered and validated pending transactions waiting to be included in a new block of the blockchain. It should be noted that the blockchain may be pruned at some nodes, and the publication of blocks can be achieved through the publication of mere block headers.

The transactions in the blockchain may be used for one or more of the following purposes: to convey a digital asset (i.e. a number of digital tokens), to order a set of entries in a virtualised ledger or registry, to receive and process timestamp entries, and/or to time-order index pointers. A blockchain can also be exploited in order to layer additional functionality on top of the blockchain. For example, blockchain protocols may allow for storage of additional user data or indexes to data in a transaction. There is no pre-specified limit to the maximum data capacity that can be stored within a single transaction, and therefore increasingly more complex data can be incorporated. For instance this may be used to store an electronic document in the blockchain, or audio or video data.

In an “output-based” model (sometimes referred to as a UTXO-based model), the data structure of a given transaction comprises one or more inputs and one or more outputs. Any spendable output comprises an element specifying an amount of the digital asset that is derivable from the proceeding sequence of transactions. The spendable output is sometimes referred to as a UTXO (“unspent transaction output”). The output may further comprise a locking script specifying a condition for the future redemption of the output. A locking script is a predicate defining the conditions necessary to validate and transfer digital tokens or assets. Each input of a transaction (other than a coinbase transaction) comprises a pointer (i.e. a reference) to such an output in a preceding transaction, and may further comprise an unlocking script for unlocking the locking script of the pointed-to output. So consider a pair of transactions, call them a first and a second transaction (or “target” transaction). The first transaction comprises at least one output specifying an amount of the digital asset, and comprising a locking script defining one or more conditions of unlocking the output. The second, target transaction comprises at least one input, comprising a pointer to the output of the first transaction, and an unlocking script for unlocking the output of the first transaction.

In such a model, when the second, target transaction is sent to the blockchain network to be propagated and recorded in the blockchain, one of the criteria for validity applied at each node will be that the unlocking script meets all of the one or more conditions defined in the locking script of the first transaction. Another will be that the output of the first transaction has not already been redeemed by another, earlier valid transaction. Any node that finds the target transaction invalid according to any of these conditions will not propagate it (as a valid transaction, but possibly to register an invalid transaction) nor include it in a new block to be recorded in the blockchain.

An alternative type of transaction model is an account-based model. In this case each transaction does not define the amount to be transferred by referring back to the UTXO of a preceding transaction in a sequence of past transactions, but rather by reference to an absolute account balance. The current state of all accounts is stored by the nodes separate to the blockchain and is updated constantly.

FIG. 1 shows an example system 100 for implementing a blockchain 150. The system 100 may comprise a packet-switched network 101, typically a wide-area internetwork such as the Internet. The packet-switched network 101 comprises a plurality of blockchain nodes 104 (often referred to as “miners”) that may be arranged to form a peer-to-peer (P2P) network 106 within the packet-switched network 101. Whilst not illustrated, the blockchain nodes 104 may be arranged as a near-complete graph. Each blockchain node 104 is therefore highly connected to other blockchain nodes 104.

Each blockchain node 104 comprises computer equipment of a peer, with different ones of the nodes 104 belonging to different peers. Each blockchain node 104 comprises processing apparatus comprising one or more processors, e.g. one or more central processing units (CPUs), accelerator processors, application specific processors and/or field programmable gate arrays (FPGAs), and other equipment such as application specific integrated circuits (ASICs). Each node also comprises memory, i.e. computer-readable storage in the form of a non-transitory computer-readable medium or media. The memory may comprise one or more memory units employing one or more memory media, e.g. a magnetic medium such as a hard disk; an electronic medium such as a solid-state drive (SSD), flash memory or EEPROM; and/or an optical medium such as an optical disk drive.

The blockchain 150 comprises a chain of blocks of data 151, wherein a respective copy of the blockchain 150 is maintained at each of a plurality of blockchain nodes 104 in the distributed or blockchain network 106. As mentioned above, maintaining a copy of the blockchain 150 does not necessarily mean storing the blockchain 150 in full. Instead, the blockchain 150 may be pruned of data so long as each blockchain node 150 stores the block header (discussed below) of each block 151. Each block 151 in the chain comprises one or more transactions 152, wherein a transaction in this context refers to a kind of data structure. The nature of the data structure will depend on the type of transaction protocol used as part of a transaction model or scheme. A given blockchain will use one particular transaction protocol throughout.

A blockchain node 104 may be configured to forward transactions 152 to other blockchain nodes 104, and thereby cause transactions 152 to be propagated throughout the network 106. A blockchain node 104 may be configured to create blocks 151 and to store a respective copy of the same blockchain 150 in their respective memory. A blockchain node 104 may also maintain an ordered set (or “pool”) 154 of transactions 152 waiting to be incorporated into blocks 151. The ordered pool 154 is often referred to as a “mempool”. This term herein is not intended to limit to any particular blockchain, protocol or model. It refers to the ordered set of transactions which a node 104 has accepted as valid and for which the node 104 is obliged not to accept any other transactions attempting to spend the same output.

In a given present transaction 152j, the (or each) input comprises a pointer referencing the output of a preceding transaction 152i in the sequence of transactions, specifying that this output is to be redeemed or “spent” in the present transaction 152j. Spending or redeeming does not necessarily imply transfer of a financial asset, though that is certainly one common application. More generally spending could be described as consuming the output, or assigning it to one or more outputs in another, onward transaction. In general, the preceding transaction could be any transaction in the ordered set 154 or any block 151. The preceding transaction 152i need not necessarily exist at the time the present transaction 152j is created or even sent to the network 106, though the preceding transaction 152i will need to exist and be validated in order for the present transaction to be valid. Hence “preceding” herein refers to a predecessor in a logical sequence linked by pointers, not necessarily the time of creation or sending in a temporal sequence, and hence it does not necessarily exclude that the transactions 152i, 152j be created or sent out-of-order (see discussion below on orphan transactions). The preceding transaction 152i could equally be called the antecedent or predecessor transaction.

Due to the resources involved in transaction validation and publication, typically at least each of the blockchain nodes 104 takes the form of a server comprising one or more physical server units, or even whole a data centre. However in principle any given blockchain node 104 could take the form of a user terminal or a group of user terminals networked together.

The memory of each blockchain node 104 stores software configured to run on the processing apparatus of the blockchain node 104 in order to perform its respective role or roles and handle transactions 152 in accordance with the blockchain node protocol. It will be understood that any action attributed herein to a blockchain node 104 may be performed by the software run on the processing apparatus of the respective computer equipment. The node software may be implemented in one or more applications at the application layer, or a lower layer such as the operating system layer or a protocol layer, or any combination of these.

Any given blockchain node may be configured to perform one or more of the following operations: validating transactions, storing transactions, propagating transactions to other peers, performing consensus (e.g. proof-of-work)/mining operations. In some examples, each type of operation is performed by a different node 104. That is, nodes may specialise in particular operation. For example, a nodes 104 may focus on transaction validation and propagation, or on block mining. In some examples, a blockchain node 104 may perform more than one of these operations in parallel. Any reference to a blockchain node 104 may refer to an entity that is configured to perform at least one of these operations.

Also connected to the network 101 is the computer equipment 102 of each of a plurality of parties 103 in the role of consuming users. These users may interact with the blockchain network 106 but do not participate in validating transactions or constructing blocks. Some of these users or agents 103 may act as senders and recipients in transactions. Other users may interact with the blockchain 150 without necessarily acting as senders or recipients. For instance, some parties may act as storage entities that store a copy of the blockchain 150 (e.g. having obtained a copy of the blockchain from a blockchain node 104).

Some or all of the parties 103 may be connected as part of a different network, e.g. a network overlaid on top of the blockchain network 106. Users of the blockchain network (often referred to as “clients”) may be said to be part of a system that includes the blockchain network 106; however, these users are not blockchain nodes 104 as they do not perform the roles required of the blockchain nodes. Instead, each party 103 may interact with the blockchain network 106 and thereby utilize the blockchain 150 by connecting to (i.e. communicating with) a blockchain node 106. Two parties 103 and their respective equipment 102 are shown for illustrative purposes: a first party 103a and his/her respective computer equipment 102a, and a second party 103b and his/her respective computer equipment 102b. It will be understood that many more such parties 103 and their respective computer equipment 102 may be present and participating in the system 100, but for convenience they are not illustrated. Each party 103 may be an individual or an organization. Purely by way of illustration the first party 103a is referred to herein as Alice and the second party 103b is referred to as Bob, but it will be appreciated that this is not limiting and any reference herein to Alice or Bob may be replaced with “first party” and “second “party” respectively.

The computer equipment 102 of each party 103 comprises respective processing apparatus comprising one or more processors, e.g. one or more CPUs, GPUs, other accelerator processors, application specific processors, and/or FPGAs. The computer equipment 102 of each party 103 further comprises memory, i.e. computer-readable storage in the form of a non-transitory computer-readable medium or media. This memory may comprise one or more memory units employing one or more memory media, e.g. a magnetic medium such as hard disk; an electronic medium such as an SSD, flash memory or EEPROM; and/or an optical medium such as an optical disc drive. The memory on the computer equipment 102 of each party 103 stores software comprising a respective instance of at least one client application 105 arranged to run on the processing apparatus. It will be understood that any action attributed herein to a given party 103 may be performed using the software run on the processing apparatus of the respective computer equipment 102. The computer equipment 102 of each party 103 comprises at least one user terminal, e.g. a desktop or laptop computer, a tablet, a smartphone, or a wearable device such as a smartwatch. The computer equipment 102 of a given party 103 may also comprise one or more other networked resources, such as cloud computing resources accessed via the user terminal.

The client application 105 may be initially provided to the computer equipment 102 of any given party 103 on suitable computer-readable storage medium or media, e.g. downloaded from a server, or provided on a removable storage device such as a removable SSD, flash memory key, removable EEPROM, removable magnetic disk drive, magnetic floppy disk or tape, optical disk such as a CD or DVD ROM, or a removable optical drive, etc.

The client application 105 comprises at least a “wallet” function. This has two main functionalities. One of these is to enable the respective party 103 to create, authorise (for example sign) and send transactions 152 to one or more bitcoin nodes 104 to then be propagated throughout the network of blockchain nodes 104 and thereby included in the blockchain 150. The other is to report back to the respective party the amount of the digital asset that he or she currently owns. In an output-based system, this second functionality comprises collating the amounts defined in the outputs of the various 152 transactions scattered throughout the blockchain 150 that belong to the party in question.

Note: whilst the various client functionality may be described as being integrated into a given client application 105, this is not necessarily limiting and instead any client functionality described herein may instead be implemented in a suite of two or more distinct applications, e.g. interfacing via an API, or one being a plug-in to the other. More generally the client functionality could be implemented at the application layer or a lower layer such as the operating system, or any combination of these. The following will be described in terms of a client application 105 but it will be appreciated that this is not limiting.

The instance of the client application or software 105 on each computer equipment 102 is operatively coupled to at least one of the blockchain nodes 104 of the network 106. This enables the wallet function of the client 105 to send transactions 152 to the network 106. The client 105 is also able to contact blockchain nodes 104 in order to query the blockchain 150 for any transactions of which the respective party 103 is the recipient (or indeed inspect other parties' transactions in the blockchain 150, since in embodiments the blockchain 150 is a public facility which provides trust in transactions in part through its public visibility). The wallet function on each computer equipment 102 is configured to formulate and send transactions 152 according to a transaction protocol. As set out above, each blockchain node 104 runs software configured to validate transactions 152 according to the blockchain node protocol, and to forward transactions 152 in order to propagate them throughout the blockchain network 106. The transaction protocol and the node protocol correspond to one another, and a given transaction protocol goes with a given node protocol, together implementing a given transaction model. The same transaction protocol is used for all transactions 152 in the blockchain 150. The same node protocol is used by all the nodes 104 in the network 106.

An alternative type of transaction protocol operated by some blockchain networks may be referred to as an “account-based” protocol, as part of an account-based transaction model. In the account-based case, each transaction does not define the amount to be transferred by referring back to the UTXO of a preceding transaction in a sequence of past transactions, but rather by reference to an absolute account balance. The current state of all accounts is stored, by the nodes of that network, separate to the blockchain and is updated constantly. In such a system, transactions are ordered using a running transaction tally of the account (also called the “position” or “nonce”). This value is signed by the sender as part of their cryptographic signature and is hashed as part of the transaction reference calculation. In addition, an optional data field may also be signed the transaction. This data field may point back to a previous transaction, for example if the previous transaction ID is included in the data field.

Some account-based transaction models share several similarities with the output-based transaction model described herein. For example, as mentioned above, the data field of an account-based transaction may point back to a previous transaction, which is equivalent to the input of an output-based transaction which references an outpoint a previous transaction. Thus both models enable linking between transactions. As another example, an account-based transaction contains a “recipient” field (in which a receiving address of an account is specified) and a “value” field (in which an amount of digital asset may be specified). Together the recipient and value fields are equivalent to the output of an output-based transaction which may be used to assign an amount of digital asset to a blockchain address. Similarly, an account-based transaction has a “signature” field which includes a signature for the transaction. The signature is generated using the sender's private key and confirms the sender has authorized this transaction. This is equivalent to an input/unlocking script of an output-based transaction which, typically, includes a signature for the transaction. When both types of transaction are submitted to their respective blockchain networks, the signatures are checked to determine whether the transaction is valid and can be recorded on the blockchain. On an account-based blockchain, a “smart contact” refers to a transaction that contains a script configured to perform one or more actions (e.g. send or “release” a digital asset to a recipient address) in response to one or more inputs (provided by a transaction) meeting one or more conditions defined by the smart contact's script. The smart contract exists as a transaction on the blockchain, and can be called (or triggered) by subsequent transactions. Thus, in some examples, a smart contract may be considered equivalent to a locking script of an output-based transaction, which can be triggered by a subsequent transaction, and checks whether one or more conditions defined by the locking script are met by the input of the subsequent transaction.

### 3. UTXO-Based Model

FIG. 2 illustrates an example transaction protocol. This is an example of a UTXO-based protocol. A transaction 152 (abbreviated “Tx”) is the fundamental data structure of the blockchain 150 (each block 151 comprising one or more transactions 152). The following will be described by reference to an output-based or “UTXO” based protocol. However, this is not limiting to all possible embodiments. Note that while the example UTXO-based protocol is described with reference to bitcoin, it may equally be implemented on other example blockchain networks.

In a UTXO-based model, each transaction (“Tx”) 152 comprises a data structure comprising one or more inputs 202, and one or more outputs 203. Each output 203 may comprise an unspent transaction output (UTXO), which can be used as the source for the input 202 of another new transaction (if the UTXO has not already been redeemed). The UTXO includes a value specifying an amount of a digital asset. This represents a set number of tokens on the distributed ledger. The UTXO may also contain the transaction ID of the transaction from which it came, amongst other information. The transaction data structure may also comprise a header 201, which may comprise an indicator of the size of the input field(s) 202 and output field(s) 203. The header 201 may also include an ID of the transaction. In embodiments the transaction ID is the hash of the transaction data (excluding the transaction ID itself) and stored in the header 201 of the raw transaction 152 submitted to the nodes 104.

Say Alice 103a wishes to create a transaction 152j transferring an amount of the digital asset in question to Bob 103b. In FIG. 2 Alice's new transaction 152j is labelled “Tx₁”. It takes an amount of the digital asset that is locked to Alice in the output 203 of a preceding transaction 152i in the sequence, and transfers at least some of this to Bob. The preceding transaction 152i is labelled “Tx₀” in FIG. 2. Tx₀ and Tx₁ are just arbitrary labels. They do not necessarily mean that Tx₀ is the first transaction in the blockchain 151, nor that Tx₁ is the immediate next transaction in the pool 154. Tx₁ could point back to any preceding (i.e. antecedent) transaction that still has an unspent output 203 locked to Alice.

The terms “preceding” and “subsequent” as used herein in the context of the sequence of transactions refer to the order of the transactions in the sequence as defined by the transaction pointers specified in the transactions (which transaction points back to which other transaction, and so forth). They could equally be replaced with “predecessor” and “successor”, or “antecedent” and “descendant”, “parent” and “child”, or such like. It does not necessarily imply an order in which they are created, sent to the network 106, or arrive at any given blockchain node 104. Nevertheless, a subsequent transaction (the descendent transaction or “child”) which points to a preceding transaction (the antecedent transaction or “parent”) will not be validated until and unless the parent transaction is validated. A child that arrives at a blockchain node 104 before its parent is considered an orphan. It may be discarded or buffered for a certain time to wait for the parent, depending on the node protocol and/or node behaviour.

One of the one or more outputs 203 of the preceding transaction Tx₀ comprises a particular UTXO, labelled here UTXO₀. Each UTXO comprises a value specifying an amount of the digital asset represented by the UTXO, and a locking script which defines a condition which must be met by an unlocking script in the input 202 of a subsequent transaction in order for the subsequent transaction to be validated, and therefore for the UTXO to be successfully redeemed.

The locking script (aka scriptPubKey) is a piece of code written in the domain specific language recognized by the node protocol. A particular example of such a language is called “Script” (capital S) which is used by the blockchain network. The locking script specifies what information is required to spend a transaction output 203, for example the requirement of Alice's signature. Locking scripts appear in the outputs of transactions. The unlocking script (aka scriptSig) is a piece of code written the domain specific language that provides the information required to satisfy the locking script criteria. For example, it may contain Bob's signature. Unlocking scripts appear in the input 202 of transactions.

So in the example illustrated, UTXO₀ in the output 203 of Tx₀ comprises a locking script [Checksig P_{A}] which requires a signature Sig P_{A} of Alice in order for UTXO₀ to be redeemed (strictly, in order for a subsequent transaction attempting to redeem UTXO₀ to be valid). [Checksig P_{A}] contains a representation (i.e. a hash) of the public key P_{A} from a public-private key pair of Alice. The input 202 of Tx₁ comprises a pointer pointing back to Tx₁ (e.g. by means of its transaction ID, TxID₀, which in embodiments is the hash of the whole transaction Tx₀). The input 202 of Tx₁ comprises an index identifying UTXO₀ within Tx₀, to identify it amongst any other possible outputs of Tx₀. The input 202 of Tx₁ further comprises an unlocking script <Sig P_{A}> which comprises a cryptographic signature of Alice, created by Alice applying her private key from the key pair to a predefined portion of data (sometimes called the “message” in cryptography). The data (or “message”) that needs to be signed by Alice to provide a valid signature may be defined by the locking script, or by the node protocol, or by a combination of these.

When the new transaction Tx₁ arrives at a blockchain node 104, the node applies the node protocol. This comprises running the locking script and unlocking script together to check whether the unlocking script meets the condition defined in the locking script (where this condition may comprise one or more criteria).

Note that the script code is often represented schematically (i.e. not using the exact language). For example, one may use operation codes (opcodes) to represent a particular function. “OP_ . . . ” refers to a particular opcode of the Script language. As an example, OP_RETURN is an opcode of the Script language that when preceded by OP_FALSE at the beginning of a locking script creates an unspendable output of a transaction that can store data within the transaction, and thereby record the data immutably in the blockchain 150. E.g. the data could comprise a document which it is desired to store in the blockchain.

Typically an input of a transaction contains a digital signature corresponding to a public key P_{A}. In embodiments this is based on the ECDSA using the elliptic curve secp256k1. A digital signature signs a particular piece of data. In some embodiments, for a given transaction the signature will sign part of the transaction input, and some or all of the transaction outputs. The particular parts of the outputs it signs depends on the SIGHASH flag. The SIGHASH flag is usually a 4-byte code included at the end of a signature to select which outputs are signed (and thus fixed at the time of signing).

The locking script is sometimes called “scriptPubKey” referring to the fact that it typically comprises the public key of the party to whom the respective transaction is locked. The unlocking script is sometimes called “scriptSig” referring to the fact that it typically supplies the corresponding signature. However, more generally it is not essential in all applications of a blockchain 150 that the condition for a UTXO to be redeemed comprises authenticating a signature. More generally the scripting language could be used to define any one or more conditions. Hence the more general terms “locking script” and “unlocking script” may be preferred.

### 4. Side Channel

As shown in FIG. 1, the client application on each of Alice and Bob's computer equipment 102a, 120b, respectively, may comprise additional communication functionality. This additional functionality enables Alice 103a to establish a separate side channel 107 with Bob 103b (at the instigation of either party or a third party). The side channel 107 enables exchange of data separately from the blockchain network. Such communication is sometimes referred to as “off-chain” communication. For instance this may be used to exchange a transaction 152 between Alice and Bob without the transaction (yet) being registered onto the blockchain network 106 or making its way onto the chain 150, until one of the parties chooses to broadcast it to the network 106. Sharing a transaction in this way is sometimes referred to as sharing a “transaction template”. A transaction template may lack one or more inputs and/or outputs that are required in order to form a complete transaction. Alternatively or additionally, the side channel 107 may be used to exchange any other transaction related data, such as keys, negotiated amounts or terms, data content, etc.

The side channel 107 may be established via the same packet-switched network 101 as the blockchain network 106. Alternatively or additionally, the side channel 301 may be established via a different network such as a mobile cellular network, or a local area network such as a local wireless network, or even a direct wired or wireless link between Alice and Bob's devices 102a, 102b. Generally, the side channel 107 as referred to anywhere herein may comprise any one or more links via one or more networking technologies or communication media for exchanging data “off-chain”, i.e. separately from the blockchain network 106. Where more than one link is used, then the bundle or collection of off-chain links as a whole may be referred to as the side channel 107. Note therefore that if it is said that Alice and Bob exchange certain pieces of information or data, or such like, over the side channel 107, then this does not necessarily imply all these pieces of data have to be send over exactly the same link or even the same type of network.

### 5. Further Remarks

Other variants or use cases of the disclosed techniques may become apparent to the person skilled in the art once given the disclosure herein. The scope of the disclosure is not limited by the described embodiments but only by the accompanying claims.

For instance, some embodiments above have been described in terms of a bitcoin network 106, bitcoin blockchain 150 and bitcoin nodes 104. However it will be appreciated that the bitcoin blockchain is one particular example of a blockchain 150 and the above description may apply generally to any blockchain. That is, the present invention is in by no way limited to the bitcoin blockchain. More generally, any reference above to bitcoin network 106, bitcoin blockchain 150 and bitcoin nodes 104 may be replaced with reference to a blockchain network 106, blockchain 150 and blockchain node 104 respectively. The blockchain, blockchain network and/or blockchain nodes may share some or all of the described properties of the bitcoin blockchain 150, bitcoin network 106 and bitcoin nodes 104 as described above.

In preferred embodiments of the invention, the blockchain network 106 is the bitcoin network and bitcoin nodes 104 perform at least all of the described functions of creating, publishing, propagating and storing blocks 151 of the blockchain 150. It is not excluded that there may be other network entities (or network elements) that only perform one or some but not all of these functions. That is, a network entity may perform the function of propagating and/or storing blocks without creating and publishing blocks (recall that these entities are not considered nodes of the preferred bitcoin network 106).

In other embodiments of the invention, the blockchain network 106 may not be the bitcoin network. In these embodiments, it is not excluded that a node may perform at least one or some but not all of the functions of creating, publishing, propagating and storing blocks 151 of the blockchain 150. For instance, on those other blockchain networks a “node” may be used to refer to a network entity that is configured to create and publish blocks 151 but not store and/or propagate those blocks 151 to other nodes.

Even more generally, any reference to the term “bitcoin node” 104 above may be replaced with the term “network entity” or “network element”, wherein such an entity/element is configured to perform some or all of the roles of creating, publishing, propagating and storing blocks. The functions of such a network entity/element may be implemented in hardware in the same way described above with reference to a blockchain node 104.

Some embodiments have been described in terms of the blockchain network implementing a proof-of-work consensus mechanism to secure the underlying blockchain. However proof-of-work is just one type of consensus mechanism and in general embodiments may use any type of suitable consensus mechanism such as, for example, proof-of-stake, delegated proof-of-stake, proof-of-capacity, or proof-of-elapsed time. As a particular example, proof-of-stake uses a randomized process to determine which blockchain node 104 is given the opportunity to produce the next block 151. The chosen node is often referred to as a validator. Blockchain nodes can lock up their tokens for a certain time in order to have the chance of becoming a validator. Generally, the node who locks the biggest stake for the longest period of time has the best chance of becoming the next validator.

It will be appreciated that the above embodiments have been described by way of example only. More generally there may be provided a method, apparatus or program in accordance with any one or more of the following Statements.
Statement 1. A computer-implemented method for outsourcing a computation using a blockchain, wherein the method is performed by a coordinating party and comprises:
   obtaining one or more respective secondary computations, wherein each respective secondary computation is based on a respective part of a primary computation and a respective verification algorithm, and wherein executing each respective secondary computation with a respective input generates a respective result of the respective part of the primary computation and a respective verification output of the respective verification algorithm;
   obtaining a plurality of respective inputs to the primary computation; and
   for each respective secondary computation:
      generating a respective outsourcing transaction, wherein the respective outsourcing transaction is locked to a respective locking value based on the respective verification output;
      making the respective outsourcing transaction available to a respective computing party; and
      making both the respective secondary computation, or an encrypted version thereof, and the respective input, or an encrypted version thereof, available to the respective computing party.
Statement 2. The method of statement 1, wherein making the respective outsourcing transaction available to the respective computing party comprises sending the respective outsourcing transaction to one or more blockchain nodes of a blockchain network.
Statement 3. The method of statement 1 or statement2, wherein making the respective secondary computation, or the encrypted version thereof, and the respective input, or the encrypted version thereof, available to the respective computing party comprises including a link or reference to the respective secondary computation, or the encrypted version thereof, and the respective input, or the encrypted version thereof, in the respective outsourcing transaction.
Statement 4. The method of any preceding statement, comprising making a decryption key for decrypting the respective secondary computation and/or the respective input available to the respective computing party.
Statement 5. The method of any preceding statement, wherein the respective outsourcing transaction comprises a hash of at least the secondary computation.
Statement 6. The method of any preceding statement, wherein the respective outsourcing transaction is locked to a respective public key of the respective computing party.
Statement 7. The method of any preceding statement, wherein the respective locking value is based on a hash of at least the respective verification output.
Statement 8. The method of statement 6 and statement 7, wherein the respective locking value is based on a hash of at least the respective verification output and the respective public key.
Statement 9. The method of any preceding statement, wherein the respective outsourcing transaction is configured to be unlocked by the coordinating party.
Statement 10. The method of any preceding statement, wherein the method comprises obtaining the primary computation from an outsourcing party.
Statement 11. The method of statement 10, wherein obtaining the respective input comprises receiving the respective input from the outsourcing party.
Statement 12. The method of statement 10 or statement 11, wherein receiving the primary computation comprises receiving a source code of the primary computation.
Statement 13. The method of any preceding statement, comprising:

obtaining a respective result of each respective secondary computation; and generating an overall result of the primary computation based on the respective result of each respective secondary computation.
Statement 14. The method of statement 13, wherein obtaining the respective result of each respective secondary computation, or the encrypted version thereof, comprises receiving the respective result, or the encrypted version thereof, from the respective computing party.
Statement 15. The method of statement 13 or statement 14, wherein for each respective outsourcing transaction, the blockchain comprises a respective result transaction, wherein the respective result transaction comprises the respective result, or the encrypted version thereof, or a link or reference thereto, and wherein obtaining the respective result of each respective secondary computation comprises obtaining the respective result, or the encrypted version thereof, from the respective result transaction or from the link or reference.
Statement 16. The method of any of statements 13 to 15 when dependent on statement 10, comprising making the overall result of the primary computation available to the outsourcing party.
Statement 17. The method of any preceding statement, comprising assigning a respective identifier to each respective secondary computation, and wherein the respective verification output is based on the respective identifier.
Statement 18. The method of statement 17 when dependent on any of statements 13 to 16, wherein the respective identifier is used to generate the overall result of the primary computation based on the respective result of each respective secondary computation.
Statement 19. The method of any preceding statement, obtaining the one or more respective secondary computations comprises splitting the primary computation into the one or more respective parts.
Statement 20. The method of any preceding statement, wherein the primary computation comprises a neural network.
Statement 21. The method of statement 20, wherein the input is training data for the neural network.
Statement 22. A computer-implemented method for performing an outsourced computation using a blockchain, wherein the method is performed by a first computing party and comprises:
   obtaining a first secondary computation, wherein the first secondary-computation comprises a primary computation or a first part of the primary computation, and a first verification algorithm;
   obtaining a first input to the primary computation;
   obtaining a first outsourcing transaction, wherein the first outsourcing transaction is locked a first locking value based a first verification output obtainable by inputting the first input to the first verification algorithm;
   executing the first secondary computation using the first input, wherein said execution produces a first result based on the primary computation or the first part of the primary computation, and the first verification output;
   making the first result, or an encrypted version thereof, available to a coordinating party;
   generating a first result transaction, wherein the first result transaction references the first outsourcing transaction and comprises an unlocking value based on the first verification output; and
   making the first result transaction available to one or more nodes of a blockchain network.
Statement 23. The method of statement 22, wherein making the first result available to the coordinating party comprises including the first result, or a link or reference to the first result, or the encrypted version thereof, in the respective outsourcing transaction.
Statement 24. The method of statement 22 or statement 23, wherein obtaining the first outsourcing transaction comprises obtaining the first outsourcing transaction from the coordinating party or from the blockchain.
Statement 25. The method of any of statements 22 to 24, wherein the first outsourcing transaction comprises a link or reference to the first secondary computation, or the encrypted version thereof, and/or a link or reference to the first input, or the encrypted version thereof, and wherein:
   obtaining the first secondary computation, or the encrypted version thereof, comprises using the link or reference to obtain the first secondary computation, or the encrypted version thereof; and/or
   obtaining the first input, or the encrypted version thereof, comprises using the link or reference to obtain the first input, or the encrypted version thereof.

The method may comprise obtaining one or more decryption keys from the coordinating party, and using the one or more decryption keys to decrypt the first secondary computation and/or the input. The method may comprise obtaining an encryption key from the coordinating party, and using the encryption key to encrypt the first result.
Statement 26. The method of any of statements 22 to 25, wherein the first outsourcing transaction is locked to a first public key of the first computing party, and wherein the first result transaction comprises a signature generated using a private key corresponding to the first public key.
Statement 27. Computer equipment comprising:
   memory comprising one or more memory units; and
   processing apparatus comprising one or more processing units, wherein the memory stores code arranged to run on the processing apparatus, the code being configured so as when on the processing apparatus to perform the method of any of statements 1 to 26.
Statement 28. A computer program embodied on computer-readable storage and configured so as, when run on one or more processors, to perform the method of any of statements 1 to 26.

According to another aspect disclosed herein, there may be provided a method comprising the actions of the coordinating party and the outsourcing party. According to another aspect disclosed herein, there may be provided a system comprising the computer equipment of the coordinating party and the outsourcing party.

1. A computer-implemented method for outsourcing a computation using a blockchain, wherein the method is performed by a coordinating party and comprises:
obtaining one or more respective secondary computations, wherein each respective secondary computation is based on a respective part of a primary computation and a respective verification algorithm, and wherein executing each respective secondary computation with a respective input generates a respective result of the respective part of the primary computation and a respective verification output of the respective verification algorithm;
obtaining a plurality of respective inputs to the primary computation; and
for each respective secondary computation:
generating a respective outsourcing transaction, wherein the respective outsourcing transaction is locked to a respective locking value based on the respective verification output;
making the respective outsourcing transaction available to a respective computing party; and
making both the respective secondary computation, or an encrypted version thereof, and the respective input, or an encrypted version thereof, available to the respective computing party.

2. The method of claim 1, wherein making the respective outsourcing transaction available to the respective computing party comprises sending the respective outsourcing transaction to one or more blockchain nodes of a blockchain network.

3. The method of claim 1, wherein making the respective secondary computation, or the encrypted version thereof, and the respective input, or the encrypted version thereof, available to the respective computing party comprises including a link or reference to the respective secondary computation, or the encrypted version thereof, and the respective input, or the encrypted version thereof, in the respective outsourcing transaction.

4. The method of claim 1, comprising making a decryption key for decrypting the respective secondary computation and/or the respective input available to the respective computing party.

5. The method of claim 1, wherein the respective outsourcing transaction:
comprises a hash of at least the secondary computation; and
is locked to a respective public key of the respective computing party.

6. (canceled)

7. The method of claim 1, wherein the respective locking value is based on a hash of at least the respective verification output.

8. (canceled)

9. The method of claim 1, wherein the respective outsourcing transaction is configured to be unlocked by the coordinating party.

10. The method of claim 1, wherein the method comprises:
obtaining the primary computation from an outsourcing party;
obtaining a respective result of each respective secondary computation;
generating an overall result of the primary computation based on the respective result of each respective secondary computation; and
making the overall result of the primary computation available to the outsourcing party.

11. The method of claim 10, wherein obtaining the respective input comprises receiving the respective input from the outsourcing party.

12. The method of claim 11, wherein receiving the primary computation comprises receiving a source code of the primary computation.

13. (canceled)

14. The method of claim 10, wherein obtaining the respective result of each respective secondary computation, or the encrypted version thereof, comprises receiving the respective result, or the encrypted version thereof, from the respective computing party.

15. The method of claim 10, wherein for each respective outsourcing transaction, the blockchain comprises a respective result transaction, wherein the respective result transaction comprises the respective result, or the encrypted version thereof, or a link or reference thereto, and wherein obtaining the respective result of each respective secondary computation comprises obtaining the respective result, or the encrypted version thereof, from the respective result transaction or from the link or reference.

16. (canceled)

17. The method of claim 10, comprising assigning a respective identifier to each respective secondary computation, wherein the respective verification output is based on the respective identifier, and wherein the respective identifier is used to generate the overall result of the primary computation based on the respective result of each respective secondary computation.

18. (canceled)

19. The method of claim 1, wherein obtaining the one or more respective secondary computations comprises splitting the primary computation into the one or more respective parts.

20. The method of claim 1, wherein the primary computation comprises a neural network and wherein the input is training data for the neural network.

21. (canceled)

22. A computer-implemented method for performing an outsourced computation using a blockchain, wherein the method is performed by a first computing party and comprises:
obtaining a first secondary computation, wherein the first secondary computation comprises a primary computation or a first part of the primary computation, and a first verification algorithm;
obtaining a first input to the primary computation;
obtaining a first outsourcing transaction, wherein the first outsourcing transaction is locked a first locking value based a first verification output obtainable by inputting the first input to the first verification algorithm;
executing the first secondary computation using the first input, wherein said execution produces a first result based on the primary computation or the first part of the primary computation, and the first verification output;
making the first result, or an encrypted version thereof, available to a coordinating party;
generating a first result transaction, wherein the first result transaction references the first outsourcing transaction and comprises an unlocking value based on the first verification output; and
making the first result transaction available to one or more nodes of a blockchain network.

23. The method of claim 22, wherein making the first result available to the coordinating party comprises including the first result, or a link or reference to the first result, or the encrypted version thereof, in the respective outsourcing transaction.

24. (canceled)

25. The method of claim 22, wherein the first outsourcing transaction comprises a link or reference to the first secondary computation, or the encrypted version thereof, and/or a link or reference to the first input, or the encrypted version thereof, and wherein:
obtaining the first secondary computation, or the encrypted version thereof, comprises using the link or reference to obtain the first secondary computation, or the encrypted version thereof; and/or
obtaining the first input, or the encrypted version thereof, comprises using the link or reference to obtain the first input, or the encrypted version thereof.

26. The method of claim 22, wherein the first outsourcing transaction is locked to a first public key of the first computing party, and wherein the first result transaction comprises a signature generated using a private key corresponding to the first public key.

27. (canceled)

28. A computer program embodied on non-transitory computer-readable storage media and configured so as, when run on one or more processors, the one or more processors are configured to:
obtain one or more respective secondary computations, wherein each respective secondary computation is based on a respective part of a primary computation and a respective verification algorithm, and wherein executing each respective secondary computation with a respective input generates a respective result of the respective part of the primary computation and a respective verification output of the respective verification algorithm;
obtain a plurality of respective inputs to the primary computation; and
for each respective secondary computation:
generate a respective outsourcing transaction, wherein the respective outsourcing transaction is locked to a respective locking value based on the respective verification output;
make the respective outsourcing transaction available to a respective computing party; and
make both the respective secondary computation, or an encrypted version thereof, and the respective input, or an encrypted version thereof, available to the respective computing party.
